(19) United States
(12) Patent Application Publication
(10) Pub. No.: US 2024/0091945 A1
(43) Pub. Date: Mar. 21, 2024

(54) INDUSTRIAL MACHINE SYSTEM

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 18/256,875

(22) PCT Filed: Feb. 22, 2022
(86) PCT No.: PCT/JP2022/007184

§ 371 Date: Jun. 9, 2023

(30) Foreign Application Priority Data
Feb. 26, 2021 (JP) 2021-030945

(51) Int. Cl. B25J 9/16; B25J 11/00; B25J 13/08

(52) U.S. Cl. CPC B25J 9/1679; B25J 9/1656; B25J 9/1697; B25J 11/005; B25J 13/085

(57) ABSTRACT

In relation to work performed by a robot, which is an industrial machine, the objective of the present invention is to enable a cause of a processing failure or abnormality to be understood easily from a stored operation history, and to enable problems that may occur in the future to be prevented. This objective can be achieved by means of a robot system configured such that: an execution history of a program for executing work on a workpiece is stored; information from sensors and information about processing results of the work performed on the workpiece are stored in association with the execution of each program block of the program; and parameter information indicating the cause of a failure in the processing results is added to the execution history when a failure occurs in the processing results.

### TECHNICAL FIELD

The present invention relates to an industrial machine system, and more particularly, to an industrial machine system that acquires information generated during a period in which the industrial machine system performs work and records the acquired information as an execution history in a storage device.

### BACKGROUND ART

For conventional robotic operation, historical information of a system acquired during the operation is stored in a storage device and used as information for estimating a current state of the system or as information for investigating a cause of an abnormality in a case of detecting the abnormality.

Patent Document 1 discloses a robotic system that, when a robot is to perform a gripping operation to grip a target object, determines a probability distribution of success and failure relating to the gripping action from visual information acquired by imaging the target object, and sets a gripping position based on the probability distribution, thereby attempting improving productivity in the gripping operation. In particular, a system configuration is described which is capable of managing operation information regarding each constituent component and historical information regarding results of determination on the gripping action.

Patent Document 2 discloses an operation history management system that collects operation historical data of an industrial robot, statistically processes the collected data to thereby set an appropriate management value for detecting an abnormality in the operation history, and facilitates investigation of a cause of deviation of the operation history from the management value.
Patent Document 1: Japanese Unexamined Patent Application, Publication No. 2019-188516
Patent Document 2: Japanese Unexamined Patent Application, Publication No. 2019-171490

### DISCLOSURE OF THE INVENTION

### Problems to be Solved by the Invention

As described above, it has been known that an operation history is stored in a robot and the stored operation history is then used for various applications. However, according to Patent Document 1, the operation information regarding each constituent component and the historical information regarding the results of determination on the gripping action indicate the results of the operations, and do not specifically indicate which setting value or the like has caused a failure that has occurred during the operation. According to Patent Document 2, the information does not indicate which value of which processing among the processing results has caused an abnormality that has occurred in the processing operation. Therefore, none of the above systems make it easy to grasp the cause of a processing failure or the cause of an abnormality, and it is difficult for the systems to prevent a problem that may arise in the future.

An object of the present disclosure is to provide an industrial machine system that stores, in a storage device, historical information of the system acquired in a period in which the system performs work. In a case where the historical information is used as information for estimating a current state of the system or as information for investigating the cause of an abnormality that has detected, the industrial machine system of the present disclosure makes it easy to grasp the cause of a processing failure and the cause of the abnormality from the stored historical information and makes it easy to identify which part of an operation program or the like should be changed, thereby enabling prevention of a problem that may arise in the future.

### Means for Solving the Problems

To achieve the above object, an industrial machine system according to the present disclosure uses a sensor to acquire information, performs work on a workpiece, and includes a storage unit configured to store an execution history of a program for performing work on the workpiece. The storage unit stores information from the sensor and information regarding a processing result of the work on the workpiece. In a case where a failure has occurred in the processing result, information indicating a cause of the failure in the processing result is added to the execution history. The information indicating the cause of the failure is derived, after execution of the program, by analyzing a cause of a failure that has occurred during the execution or a cause of a failure that may occur in a future, and indicates which data value in the processing result has caused the failure.

### Effects of the Invention

In a case where a failure has occurred in an execution history of a program for a robot as an industrial machine system due to execution of the program, the industrial machine system according to the present disclosure makes it possible to easily grasp a cause of the failure, i.e., what value in what item in the execution history of the program has caused the processing failure, and makes it possible to prevent a problem that may arise in the future.

### BRIEF DESCRIPTION OF THE DRAWINGS

FIG. 1 is a configuration diagram illustrating a relationship among a robot, a robot control device, and an image processing device according to one embodiment of the present disclosure;

FIG. 2 is a block diagram illustrating a robotic system according to one embodiment of the disclosure;

FIG. 3 is a diagram illustrating an example of a program execution history screen according to the present disclosure;

FIG. 4 is a diagram illustrating an example of a program editing screen according to the present disclosure; and

FIG. 5 is a flowchart illustrating one embodiment of the present disclosure.

### PREFERRED MODE FOR CARRYING OUT THE INVENTION

Embodiments of the present disclosure will be described in detail with reference to the drawings.

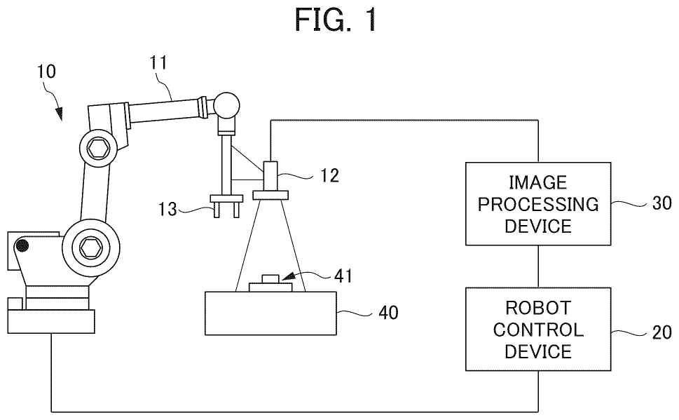

FIG. 1 is a configuration diagram illustrating a relationship among a robot, a robot control device, and an image processing device in one embodiment of a robotic system that is an industrial machine system according to the present disclosure. The robot 10 illustrated in FIG. 1 is an articulated robot having an articulated arm 11, and can perform orthogonal motion and rotational motion. Due to a restriction on a mechanism unit of the robot, for each of the motion shafts of the robot, an upper limit value and a lower limit value are set for a movement distance allowed in the orthogonal motion, and an upper limit value and lower limit value are set for a rotation angle allowed in the rotational motion. Thus, each motion shaft is operable within the respective preset range.

A visual sensor 12 and a gripper 13 are provided at the distal end of the articulated arm 11. For example, a camera is used as the visual sensor, and captures an image of a workpiece 41, which is a target object, placed on a table 40. The image information regarding the image captured by the camera, which is the visual sensor 12, is transmitted to the image processing device 30, and then processed there.

The processed image information resulting from the processing performed by the image processing device 30 is transmitted to the robot control device 20. Based on the transmitted processed image information, the robot control device 20 controls and causes the robot 10 to operate the articulated arm 11 so as to grip the workpiece 41 on the table 40 using the gripper 13, such as a hand, attached at the distal end of the articulated arm 11.

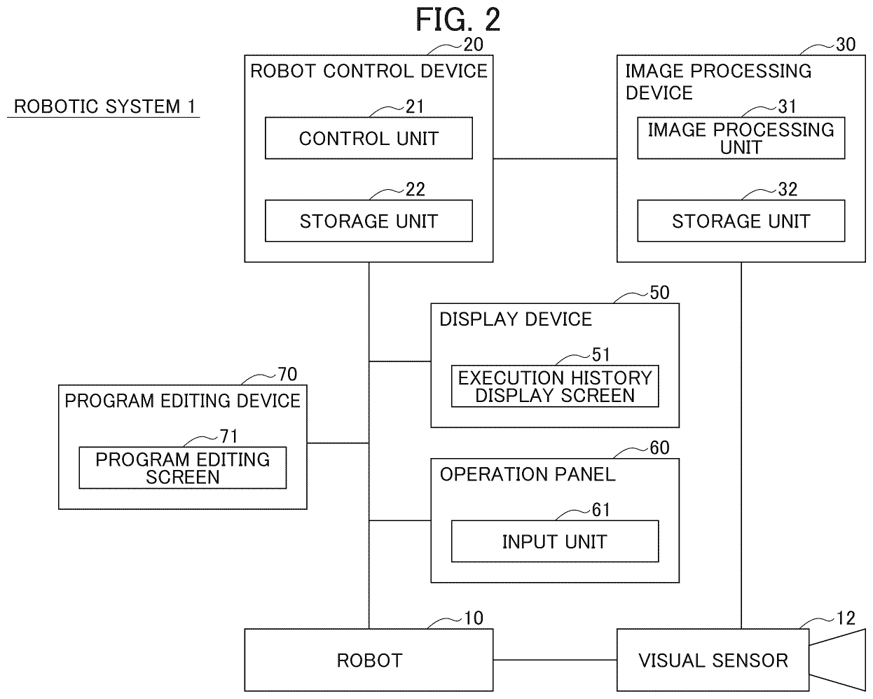

FIG. 2 is a block diagram illustrating a robotic system 1, which is an industrial machine system of the present disclosure. As illustrated in FIG. 2, the robotic system 1 of the present disclosure includes the robot 10, the robot control device 20, the image processing device 30, a display device 50, an operation panel 60, and a program editing device 70.

The visual sensor 12 having an imaging element is attached to the distal end of the articulated arm 11 of the robot 10. The visual sensor 12 captures an image of the workpiece 41, which is a target object, placed on the table 40. It should be noted that while the visual sensor 12 of the present embodiment is attached to the distal end of the articulated arm 11 of the robot 10, the visual sensor 12 may be stationarily installed. In this case, the visual sensor 12 can capture images of not only the workpiece 41 as the target object but also the robot 10 itself.

The robot control device 20 includes a control unit 21 and a storage unit 22. The control unit 21 includes a processing unit (CPU) composed of a microcomputer or the like, and controls and causes the robot 10 to grip the workpiece 41 using the gripper 13 attached to the distal end of the articulated arm 11 of the robot 10, based on a result of calculation by the processing unit (CPU).

The storage unit 22 includes a storage element such as a ROM and a RAM, stores a program for the robot 10 to perform motion and various parameters necessary for executing the motion. Furthermore, the storage unit 22 at least temporarily stores image information transmitted from the image processing device 30, information regarding an inputted value transmitted from the operation panel 60, and other information.

When a program is executed to cause the robot 10 to perform work on the workpiece 41, the storage unit 22 further stores an execution history and information regarding processing results of the work. The information regarding the processing results of the work is stored, every time each of program blocks of the program is executed, in association with the program block, together with the information regarding the image transmitted from the image processing device 30 and the information regarding the inputted value transmitted from the operation panel 60.

In addition, when the processing results include a cause of a failure, information indicating the cause of the failure in the processing results is also stored in the storage unit 22. This information is derived after execution of the program, by way of an analysis of a cause of a failure at the time of execution or after a lapse of a certain period of time from the execution, and indicates which data value in the processing results is the cause of failure.

The image processing device 30 includes an image processing unit 31 and a storage unit 32. The image processing unit 31 includes a processing unit (CPU) composed of a microcomputer or the like, controls the visual sensor 12, and processes the captured image information transmitted from the visual sensor 12 by the processing unit (CPU) using a vision program.

The vision program is a program for controlling the visual sensor 12 and processing the captured image information regarding the image captured by the visual sensor 12, and is created, set, and used by a user. The image data processed by the vision program is transmitted to the control unit 21 of the robot control device 20 and used as data for controlling the robot 10.

As described above, the visual sensor 12 does not have to be attached to the distal end of the articulated arm 11 of the robot 10, and may be stationarily installed. In this case, the captured image information transmitted from the visual sensor 12 includes not only captured image information regarding the workpiece 41 as the target object but also captured image information regarding the robot 10 itself, and accordingly, information regarding a position and a posture of the robot 10 is also transmitted from the visual sensor 12 to the image processing device 30.

The visual sensor 12 attached to the distal end of the articulated arm 11 of the robot 10 may be provided with a sensor member that detects a position and an imaging direction of the visual sensor 12 itself. In this case, information regarding the position and posture of the visual sensor 12 itself is transmitted from the visual sensor 12 to the image processing device 30.

The storage unit 32 includes a storage element such as a ROM and a RAM, at least temporarily stores captured image information transmitted from the visual sensor 12, and stores the vision program and data of various parameters necessary for executing the vision program.

The display device 50 has an execution history display screen 51 that displays the execution history of a program. On the execution history display screen 51, the execution history that indicates results of execution by the robot 10 is displayed together with the captured image transmitted from the visual sensor 12.

As will be described later in detail, in a case where a failure has occurred in processing by a program for the robot 10 to perform work during execution of the program, the execution history displayed on the execution history display screen 51 can indicate information regarding a parameter that has caused the failure in the processing results.

The operation panel 60 includes an input unit 61 that allows for input of operation data necessary for executing the program for the robot 10 to perform work. The user can input the operation data via the input unit 61 before executing the program for the robot 10 to perform work or during the execution of the program.

When a failure has occurred in processing by the program executed with the input value inputted by the user via the input unit 61 of the operation panel 60, the operation panel 60 can notify to the user parameter information indicating the cause of the failure in the processing results.

The program editing device 70 has a program editing screen 71 that allows the user to edit the program for the robot 10 to perform work. Via the program editing screen 71, the user can edit the program for the robot 10 to perform work prior to execution of the program, and can change a part of the program so as to try out a partial program related to the changed part even during execution of the program. Furthermore, it is possible to reproduce a working state of the robot 10 by reading the execution history of the program.

In a case where a failure has occurred in the processing by the program, the user can read the execution history of the program on the program editing screen 71 of the program editing device 70 to reproduce the working state of the robot 10, and make the program editing screen 71 display the information regarding the parameter that has caused the failure in the processing.

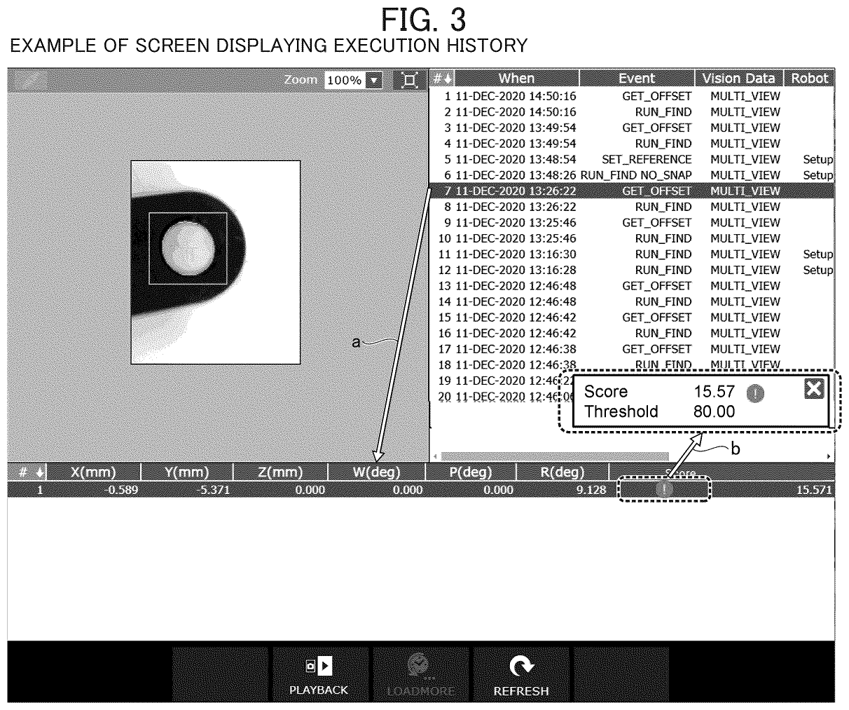

FIG. 3 illustrates an example of an execution history that can be displayed on the execution history display screen 51 of the display device 50. The execution history display screen displays, on its left side portion, captured image information transmitted from the visual sensor 12. In the present embodiment, captured image information of an imaging target portion of the workpiece 41 imaged by the camera as the visual sensor 12 is displayed. In this example, it is appreciated that the workpiece 41 has a hole.

On the other hand, the execution history display screen displays, on its right side portion, an execution history of a program that has been executed to cause the robot 10 to perform work. The user can track the displayed execution history and identify in which item of the execution history a problem has arisen. FIG. 3 illustrates that the seventh line of the execution history, which is highlighted, is being investigated.

Data indicating processing results related to the highlighted row (part) of the execution history is displayed in a bottom area extending over the display screen from the captured image information display area in the left side portion to the execution history display area in the right side portion displays. In the present embodiment, the articulated arm 11 of the robot 10 is a multi-joint arm having six degrees of freedom, and data shown as the processing results include distance data X (mm), Y (mm), and Z (mm), angle data W (deg), P (deg), and R (deg) that are related to the six degrees of freedom, and data related to detected scores.

In this example, the item corresponding to the seventh line of the execution history displayed on the right side area of the screen of the execution history is under investigation, and data indicating the processing results of the item of the seventh line under investigation is displayed in the bottom area of the screen, as indicated by the arrow a.

In a detected score (Score) field for the data indicating the processing results, an icon of an exclamation mark (!) is displayed, and accordingly, it is appreciated that an abnormality occurred in the detected score, the target object (target portion of the workpiece 41) was not detected, and the processing failed. In this way, when an abnormality has occurred in a data value, the icon of “!” mark is displayed instead of the respective data value.

Here, when the icon of “!” mark in the detected score (Score) field for the data indicating the processing results is tapped, a pop-up window appears to display therein the detected score value (Score: 15.57) and a corresponding threshold value (Threshold: 80.00), as indicated by the arrow b. In this case, the detected score value is smaller than the threshold value, which indicates that the target object was not detected.

As described above, according to the embodiment of the present disclosure, when a processing failure has occurred during execution of the program for the robot 10 to perform work, the user can easily and efficiently grasp what processing item in the execution history has caused the failure and grasp parameter information regarding which data value in the processing results has caused the failure, by means of the execution history display screen 51 of the display device 50.

The parameter information regarding the above-described processing failure enables, after execution of the program, an analysis of the cause of the failure at the time of execution based on statistical data such as an average and a variance, thereby allowing efficient derivation of an item that may cause a future failure. As a result, the program can be efficiently and properly edited, and a problem that may arise in the future due to execution of the program can be prevented.

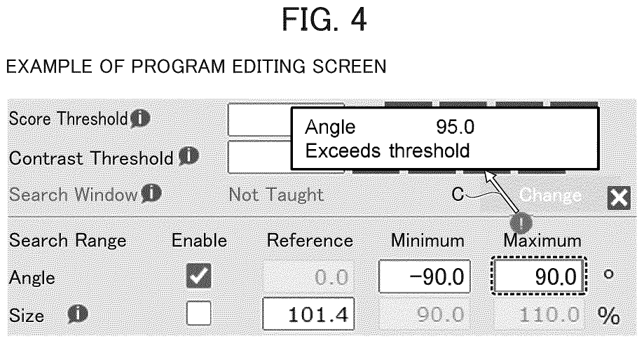

FIG. 4 illustrates an example of a display area for program execution result, on a program editing screen 71 of the program editing device 70. The display area for program execution result displays, in its upper portion, a threshold value of a score, a threshold value of contrast, and the like, and displays, in its lower portion, a checkbox for the user to determine whether to enable specification of an angle range and a size range based on respective maximum and minimum values, together with the respective reference values, minimum values, and maximum values.

In this example, since the determination about the angle is enabled by the user, the minimum value (=−90.0) and the maximum value (=90.0) are displayed. With respect to the size, the range specification is not enabled by the user, the maximum value and the minimum value are not displayed, and only the reference value (=101.4) is displayed. When the user checks the checkbox for the size to enable the determination, the field for the minimum value and the filed for the maximum value will be displayed.

An icon of “!” mark is displayed on the characters “Maximum” shown near the field for the maximum value. From this, it can be appreciated that the maximum value of the angle in the processing results of the execution of the program had a problem that caused a processing failure.

When the icon of “!” mark displayed on the characters “Maximum” near the field for the maximum value is tapped, a pop-up window appears to display therein the value of an angle (Angle=95·0) and a message (“Exceeds threshold”) indicating that the value exceeds the threshold value are displayed, as indicated by the arrow c.

As described above, according to the embodiment of the present disclosure, in a case where a processing failure has occurred due to the execution of the program edited via the program editing screen 71, the program editing screen 71 of the program editing device 70 also allows the user to easily and efficiently grasp parameter information regarding which data value in the processing results has caused the failure as a result of the editing of the program.

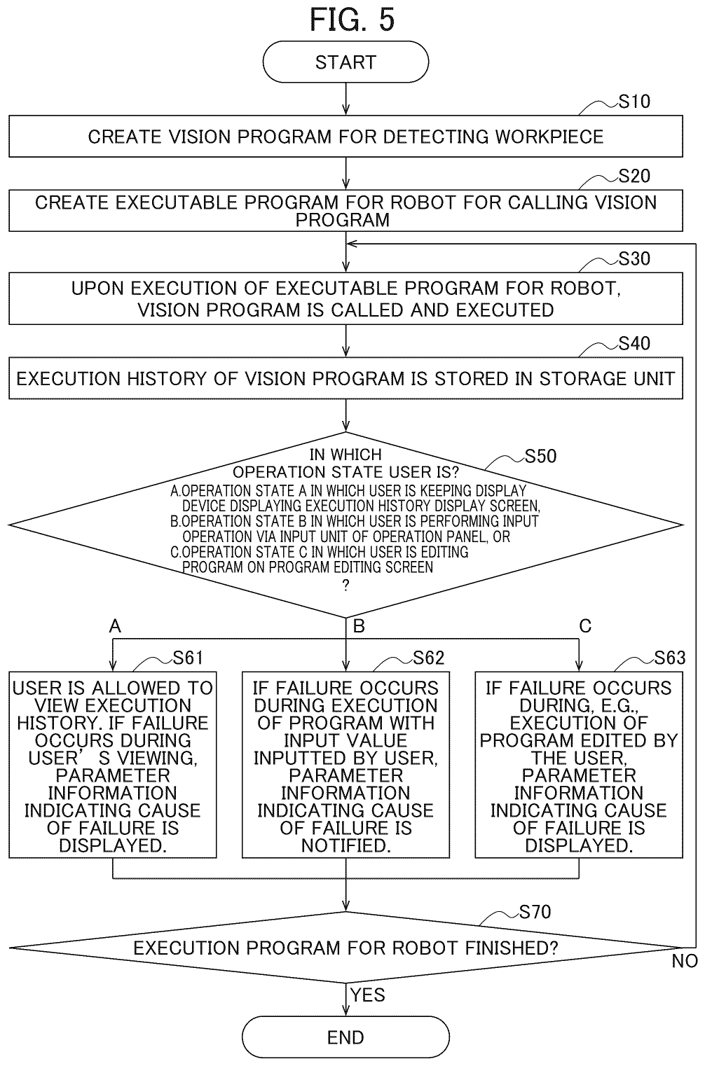

Next, one embodiment of the present disclosure will be described with reference to a flowchart of FIG. 5. First, a user creates a vision program for detecting a workpiece (Step S10). This vision program requires the user to set various parameters in order to detect the workpiece.

Next, a program for robot for calling the vision program is created (Step S20). In response to execution of the program for robot, the vision program is called and executed (Step S30).

In accordance with the execution of the vision program, an execution history is stored in a storage unit (Step S40). In the above-described example, the execution history is stored in the storage unit 22 of the robot control device 20. However, the execution history may be stored in the storage unit 32 of the image processing device 30.

In the execution history, execution date and time, a vision program name, an image captured by the visual sensor 12, an imaging position of the visual sensor 12, a detected score, contrast, detection position and posture, and the like are recorded. When a value of the detected score, the contrast, the detection position and posture, etc., which are parameters having a range defined by upper and lower limit values or having a threshold value, becomes outside the range defined by the upper and lower limit values or becomes greater (or smaller) than the threshold value, it is determined that a processing failure such as a detection failure has occurred, and information indicating that processing has failed and a value at that point in time are stored in association with the execution history.

Furthermore, for the detected score, the contrast, the detection position and posture, etc., which are parameters having a range defined by upper and lower limit values or having a threshold value, if a distance (difference) between a statistical value such as an average value and the upper or lower limit value or the threshold value allows a prediction that a processing failure such as a detection failure may occur if the program is executed in a current state, information indicating the possibility of the processing failure and the value at that point in time are recorded in association with the execution history.

The subsequent display processing differs depending on a state of operation that the user performs. Specifically, subsequent display processing differs depending on the following operation states A to C: the operation state A in which the user is keeping the display device 50 displaying the execution history display screen 51; the operation state B in which the user is performing input operation via the input unit 61 of the operation panel 60; and the operation state C in which the user is editing the program on the program editing screen 71 of the program editing device 70. Therefore, it is determined whether the user is in the operation state A, B or C (Step S50).

When the determination result in Step S50 indicates the operation state A, that is, when it is determined that the user is keeping the display device 50 displaying the execution history display screen 51, the user is allowed to view the execution history. In a case where a processing failure has occurred in the execution history being viewed, parameter information indicating the cause of the failure is displayed (Step S61).

When the determination result in Step S50 indicates the operation state B, that is, when the user is performing an input operation via the input unit 61 of the operation panel 60, the user is allowed to execute the program with the values inputted by the user. In a case where a processing failure occurs during the execution of the program, parameter information indicating the cause of the failure is notified (Step S62). It should be noted that the robot is capable of automatically operating, and the program may be executed even when an input operation is not being performed. Also in such a case, when a processing failure occurs during the execution of the program, parameter information indicating the cause of the failure is notified.

When the determination result in Step S50 indicates the operation state C, that is, when the user is editing the program on the program editing screen 71 of the program editing device 70, the user is allowed to execute the edited program or read a program from the execution history to reproduce a working state. After execution of the program, the user can open the program editing screen 71 to select an execution history. In a case where a processing failure occurs during execution of the program edited by the user, a processing failure occurs in the reproduction of a working state by an program read from the execution history, or a processing failure occurs in the selection of an executable history after execution of a program, parameter information indicating the cause of the failure is displayed (Step S63).

Next, it is determined whether or not the program for robot has finished (Step S70). When the determination result in Step S70 is YES, that is, when the program for robot has finished, this flow ends. On the other hand, when the determination result in Step S70 is NO, that is, when the program for robot has not yet finished, the flow returns to Step S30, and thereafter, the flow proceeds up to Step S70 again, and the loop of Steps S30, S40, S50, one of S61 to S63, and 370 is repeated until the determination in Step S70 results in YES, i.e., until the program for robot finishes.

In the above-described embodiment, the robot 10 detects the workpiece 41 and grips the workpiece 41 by the gripper 13 attached to the distal end of the articulated arm 11. In another embodiment, the robot 10 performs force control on the workpiece 41.

In this embodiment, the user creates a force control program for performing force control on the workpiece 41. For this force control program, the user sets various parameters necessary for performing the force control on the workpiece 41. For example, in a case of performing copying motion or tracking motion with respect to the workpiece, it is necessary to set a range of force (load) that is permitted to be applied in each axial direction of the articulated arm 11 of the robot 10.

Next, a program for robot for calling the force control program is created. When the program for robot is called, the force control program is called and executed. In accordance with execution of the force control program, an execution history is stored in the storage unit 22 or 32. The subsequent processes such as display on the display device 50 are the same as those in the above-described embodiment in which the robot 10 detects and grips the workpiece 41, and therefore, the description thereof is omitted.

In this embodiment in which the robot 10 performs force control on the workpiece 41, a force sensor is attached to the robot 10, and the robot 10 performs work on the workpiece 41 while detecting a force applied to the workpiece 41 by the force sensor. The force sensor may be torque sensors attached to the shafts of the articulated arm 11 of the robot 10. The force sensor may have a sensor member attached thereto to detect a position and a posture of the force sensor itself.

Information regarding the position and posture of the force sensor is transmitted to the robot control device 20 together with output information from the force sensor, i.e., information regarding the force (load) applied to the workpiece 41, and is used to control the robot 10.

In the robotic system of the present disclosure, the information from the sensor and the information regarding the processing results of work on the workpiece are stored in association with each other for each executed program block of the program, together with the execution history of the program for performing work on the workpiece, and further, parameter information regarding the cause of a processing failure is stored and displayed. As a result, when a failure occurs in the processing results, the user can easily grasp which value of which processing in which part of the execution history has caused the processing failure, and can prevent a problem that may arise in the future.

Furthermore, the parameter information regarding the cause of a processing failure is notified and displayed not only on the display device on which the execution history of the program is displayed but also on the operation panel via which investigation information is inputted and the program editing device via which the program is edited. Due to this feature, the user can grasp, without delay, the processing failure and the cause thereof in various operation scenes and quickly address the failure.

While embodiments of the present invention have been described above, the present invention is not limited to the embodiments described above. It is needless to say that the present invention can be implemented in various manners without deviating from the spirit of the present invention.

### EXPLANATION OF REFERENCE NUMERALS

1: Robotic System
10: Robot
11: Articulated arm
12: Visual sensor (Camera)
13: Gripper
20: Robot control device
21: Control unit
22: Storage unit
30: Image processing device
31: Image processing unit
32: Storage unit
40: Table
41: Workpiece
50: Display device
51: Execution history display screen
60: Operation panel
61: Input unit
70: Program editing device
71: Program editing screen

1. An industrial machine system that uses a sensor to acquire information and performs work on a workpiece, the industrial machine system comprising:
a storage unit configured to store an execution history of a program for performing work on the workpiece, wherein
the storage unit stores information from the sensor and information regarding a processing result of the work on the workpiece,
in a case where a failure has occurred in the processing result, information indicating a cause of the failure in the processing result is added to the execution history, and
the information indicating the cause of the failure is derived, after execution of the program, by analyzing a cause of a failure that has occurred during the execution or a cause of a failure that may occur in a future, and indicates which data value in the processing result has caused the failure.

2. The industrial machine system according to claim 1, wherein
the sensor comprises a visual sensor,
the industrial machine system detects a workpiece using the visual sensor and performs work on the detected workpiece,
information from the sensor includes captured image information and at least one of position information regarding an industrial machine at a time of performing the work or posture information regarding the industrial machine at the time of performing the work, and
the information regarding the processing result includes information regarding a detection result of the workpiece and information regarding non-detection/detection error of the workpiece.

3. The industrial machine system according to claim 1, wherein
the sensor comprises a force sensor,
the industrial machine system performs work on the workpiece while detecting a load using the force sensor,
information from the force sensor includes information regarding an output from the force sensor and at least one of position information regarding an industrial machine at a time of performing the work or posture information regarding the industrial machine at the time of performing the work, and
the information regarding the processing result includes information regarding a result of processing of the output from the force sensor.

4. The industrial machine system according to claim 1, further comprising:
a display device having an execution history display screen configured to display the execution history, wherein
in a case where a failure has occurred in processing by the program, the execution history displayed on the execution history display screen of the display device shows parameter information indicating a cause of the failure.

5. The industrial machine system according to claim 1, further comprising:
an operation panel having an input unit configured to allow a user to perform an input when the program is being executed, wherein
in a case where a failure has occurred in processing by the program executed with an input value inputted via the operation panel by the user, parameter information indicating a cause of the failure is notified to the user.

6. The industrial machine system according to claim 1, further comprising:
a program editing device having a program editing screen configured to allow editing of the program, wherein
in a case where a failure occurs in processing by the program, the execution history of the program is read on the program editing screen of the program editing device so as to reproduce a state of work on the workpiece, and parameter information indicating a cause of the failure is displayed on the program editing screen.

7. An industrial machine system that uses a sensor to acquire information and performs work on a workpiece, the industrial machine system comprising:
a storage unit configured to store an execution history of a program for executing work on the workpiece; and,
a program editing device having a program editing screen configured to allow editing of the program, wherein
in a case where a failure has occurred in processing by the program, the execution history of the program is read on the program editing screen of the program editing device so as to reproduce a state of work on the workpiece,
a cause of a failure at a time of execution or a cause a failure that may occur in a future is analyzed, and
information indicating the analyzed cause of the failure is displayed on the program editing screen.
